(19) United States
(12) Patent Application Publication
(10) Pub. No.: US 2007/0012143 A1
(43) Pub. Date: Jan. 18, 2007

(54) Socket for socket wrench

(76) Inventor: Gary E. Tracy, Marsing, ID (US)

Correspondence Address: PEDERSEN & COMPANY, PLLC, P.O. BOX 2666, BOISE, ID, 83701, US

(21) Appl. No.: 11/391,929

(22) Filed: Mar. 28, 2006

Related U.S. Application Data
(60) Provisional application No. 60/699,225, filed on Jul. 13, 2005.

(51) Int. Cl. B25B 13/00

(52) U.S. Cl. 81/124.2

(57) ABSTRACT

A socket for a wrench adapted to remove or install a 90-degree elbow on a dishwasher for attaching the waterline to the water conduit on the dishwasher. The 90-degree elbow comprising a polyhedral main body portion having two arm extensions or ends at a right angle to one another; one end being adapted to connect to the water conduit on the dishwasher and the other end being adapted to connect to the waterline. The socket includes a main body with a central cavity and a notch in the main body for receiving the main body portion of the elbow, so that the waterline end on the elbow extends out through the notch in the socket. The socket further comprises a drive end having a driver configured to cooperate with a driver on a socket wrench or other ratcheting wrench.

### BACKGROUND OF THE INVENTION

This application claims priority of our prior, co-pending provisional patent application, Ser. 60/699,225, filed on Jul. 13, 2005, entitled “Socket for Socket Wrench,” which is incorporated herein by reference.

1. Field of the Invention

The present invention relates to a socket for a ratchet wrench, and more particularly, to a socket for a ratchet wrench configured to cooperate with a common plumbing fitting known as a “dishwasher 90.” The socket is for use in loosening and tightening the dishwasher 90.

2. Description of the Related Art

Dishwasher elbow fittings are often found in very confined locations, which makes the task of loosening or tightening the elbow joint for the purpose of disconnecting or connecting it very difficult. In addition to a confined space, the elbow fitting may also be adjacent to other relatively immovable objects, adding further restriction to its rotational movement.

Farnan et al., U.S. Design Pat. No. 376,521 describes a design for a universal basin socket in which there are several stepped levels within the receiving region of the socket body for receiving different sized parts. This design places the socket driver port on the side of the socket body.

Gammon, U.S. Pat. No. 6,701,807, describes a socket device with an off-center slot for loosening and tightening connectors in confined locations. The socket device relates particularly to loosening and tightening nuts and washers used to connect pipes and tubing to basin faucet connections. A socket driver port located in the opposing second face of the socket has a centerline that is offset from the centerline of the socket body but remains within the dimensions of the socket body.

Farrell et al., U.S. Published Application No. 2004/0020336, describes a tool for quick removal and installation of a drain, in which a generally circular central body has a plurality of spokes extending from the outside peripheral edge of said central body. The spokes are spaced to be mounted into the channels of an internal nut of a standard drain fixture. The central body has a non-circular opening configuration to accept insertion of a user-supplied lever for removing or tightening the internal nut.

Molter, U.S. Published Application No. 2005/0121901, describes a toilet valve quick connect system in which an upper housing has a capture chamber which facilitates the operation of a capture nut with oversized outward peripheral portions to enable it to be turned within the confines of a typical toilet tank.

### BRIEF SUMMARY OF THE INVENTION

When an individual must install, repair, or replace a dishwasher, they may have to disconnect and/or replace the 90-degree elbow, known in the art as a “dishwasher 90”, which connects the waterline to the dishwasher. The generally L-shaped elbow comprises a main body portion, a water conduit end to the dishwasher, and a waterline end from the water supply. The main body typically has a polyhedral base with external threads disposed vertically above the base to threadably engage a water conduit on the dishwasher, and external threads, on a nipple at a right angle with the main body portion, for receiving a threaded nut. The threaded nut connects the waterline to the elbow. The elbow is hollow so that water may pass from the waterline into the water conduit and to the dishwasher. The elbow is difficult to remove or install with a traditional socket wrench due to the polyhedral base and the L-shape. Additionally, it is difficult to access the elbow due to its location behind the dishwasher kickplate and on the underside of the dishwasher unit between the dishwasher and the kitchen floor. The invented socket permits easy removal and installation of a dishwasher 90, and is also small making it easy to fit in the space underneath the dishwasher for the user to access the elbow.

The present invention relates to a socket adapted to remove or install a 90-degree elbow on a dishwasher. The preferred socket comprises a generally cylindrical main body having a drive end, a receiving end, a central cavity, and a notch in the side of the main body. The driving end comprises an inner, or female, drive opening which receives a drive shaft member from a ratchet-type wrench, or other wrench mechanism, to transmit a torque from the wrench to the 90-degree elbow. The female drive opening is preferably square; however, the drive end may have a castellated opening, a female hex-shaped opening, or any other shaped opening adapted to receive a driving wrench. Also, the drive end in an alternative embodiment may comprise an outwardly extending, male type means, for example, a square or hex post, or any other shaped shaft adapted to be received by a driving wrench.

In the preferred embodiment, the central cavity of the socket is defined by a polyhedral-shaped surface adapted to cooperate with the outer surface of the main body of the elbow. The waterline end on the elbow is received in the notch in the side of the socket. When an individual wishes to remove or install the elbow, the invented socket is attached to a wrench and cupped around the elbow, so that the main body of the elbow is received in the central cavity of the socket, and the waterline end of the elbow is received in the notch of the socket. The individual then ratchets the wrench in order to either disengage the elbow from the water conduit or install the elbow in the water conduit. The preferred socket, therefore, engages the elbow by a plurality of means including partially surrounding or cupping the main body of the elbow with a socket cavity, and by partially surrounding the neck and or waterline end with a notch in the socket body. The overall height of the socket is only slightly greater than the height of the main body of the “dishwasher 90” and the total height of the socket operably connected to the wrench permits the wrench and socket to easily fit between the dishwasher and the floor in the 3-5 inches of space typically provided.

### BRIEF DESCRIPTION OF THE DRAWINGS

FIG. 1 is an exploded side view of one embodiment of the 90-degree elbow.

FIG. 2 is a bottom view of the embodiment shown in FIG. 1.

FIG. 3 is a top perspective view of one embodiment of the preferred socket.

FIG. 4 is a bottom perspective view of the embodiment shown in FIG. 3.

FIG. 5 is a top perspective view of the embodiment shown in FIG. 3, with the partial 90-degree elbow inserted in the socket.

FIG. 6 is a side view of the dishwasher environment for the socket.

### DETAILED DESCRIPTION OF THE INVENTION

Referring to the Figures, there is shown one, but not the only embodiment of the invented socket for a 90-degree elbow for a dishwasher. The preferred socket 100 is configured to cooperate with a socket wrench for removing or installing a 90-degree elbow 200 on a dishwasher. The socket 100 is fitted to a wrench and the user ratchets the wrench to transmit torque from the wrench to the 90-degree elbow 200 in order to either secure the elbow 200 to a water conduit, or to remove the elbow 200 from the water conduit.

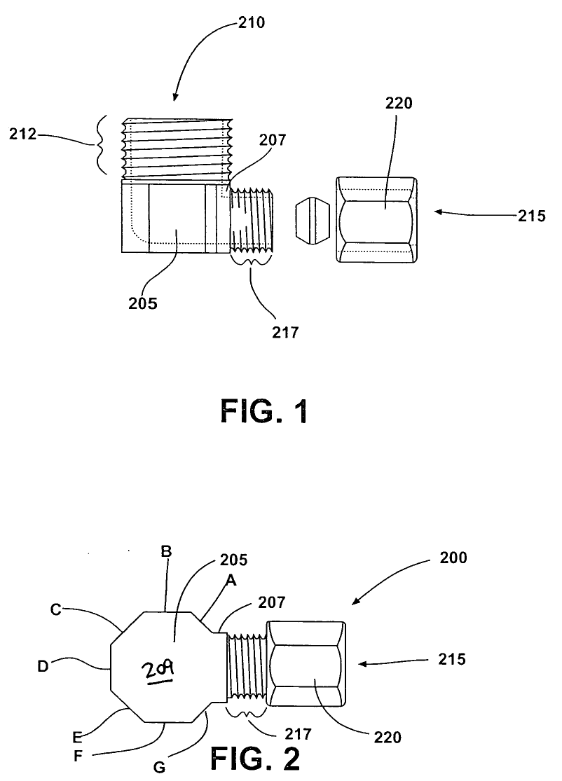

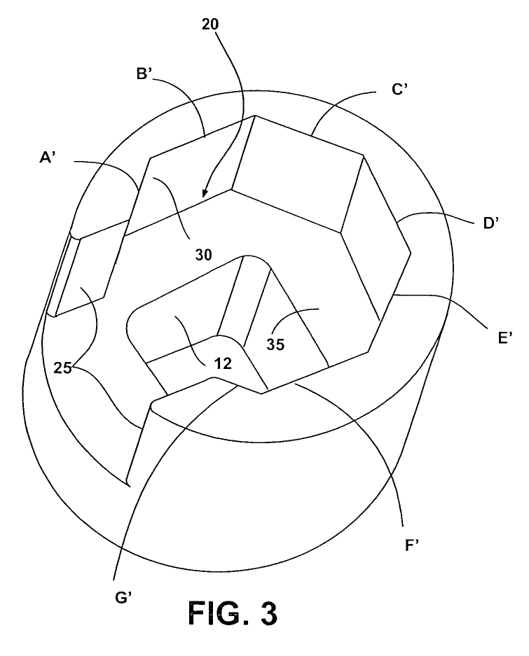

In a typical dishwasher, the waterline is connected to the water conduit on the dishwasher via a 90-degree elbow 200, also known as a “dishwasher 90”. As shown in FIGS. 1 and 2, the L-shaped elbow 200 comprises a polyhedral main body portion 205 having two arm extensions or ends 210, 215 at a right angle to one another. The interior of the elbow 200 is hollow to allow water to pass through. In this particular elbow embodiment 200, the main body 205 is partially polyhedral in shape having seven sides A, B, C, D, E, F, and G and a bottom surface 209. The conduit end 210 comprises external threads 212 for threadably connecting the elbow 200 to the water conduit on the underside of the dishwasher. The main body 205 further comprises a neck portion 207 from which the waterline end 215 extends. The waterline end 215 comprises threads 217 for receiving a nut 220. The interior of the nut 220 receives a metal ring or other sealing member that cooperates with the waterline, in turn creating a fluid connection between the waterline, the elbow 200, and the dishwasher.

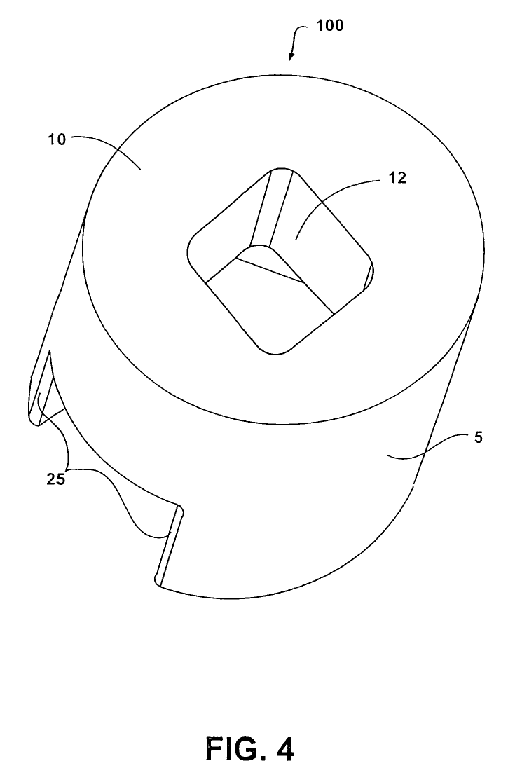

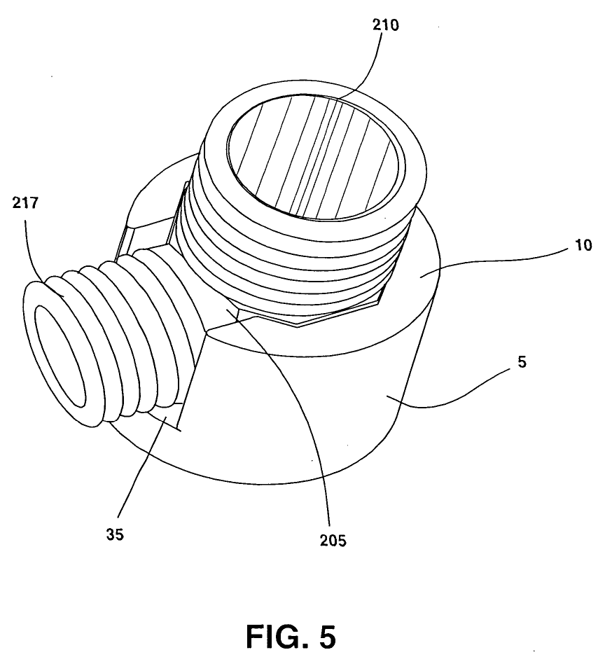

As shown in FIGS. 3 and 4, the preferred socket 100 comprises a generally cylindrical main body 5, a drive end 10, a receiving end 10, a central cavity 20, and an interior surface 30 defining the central cavity 20. The drive end 10 comprises an interior, or female driver 12 (see FIG. 4) configured to cooperate with male drive projection on a socket wrench, or other ratcheting-type wrench. The drive illustrated is a square female drive 12 adapted to receive a square male drive projection on a wrench; however other female drive shapes may be used, such as a hex-shaped female drive or, alternatively, the driving end may have a castellated opening, a male hex-shaped or square-shaped opening, or any other shaped opening adapted to cooperate with a drive on a wrench. The main body 5 of the socket 100 comprises a notch 25 or opening for receiving the neck 207 and waterline end 215 of the elbow 200.

In the preferred embodiment, the socket 100 comprises a central cavity 20 defined by an interior surface 30 of the socket 100 and an abutment shelf 35. Alternative embodiments may not include the abutment shelf 35. The interior surface 30 of the socket 100 is preferably polyhedral in shape and corresponds to the shape of the main body 205 of the elbow 200. In the preferred embodiment, the interior surface 30 comprises seven sides A′, B′, C′, D′, E′, F′, and G′.

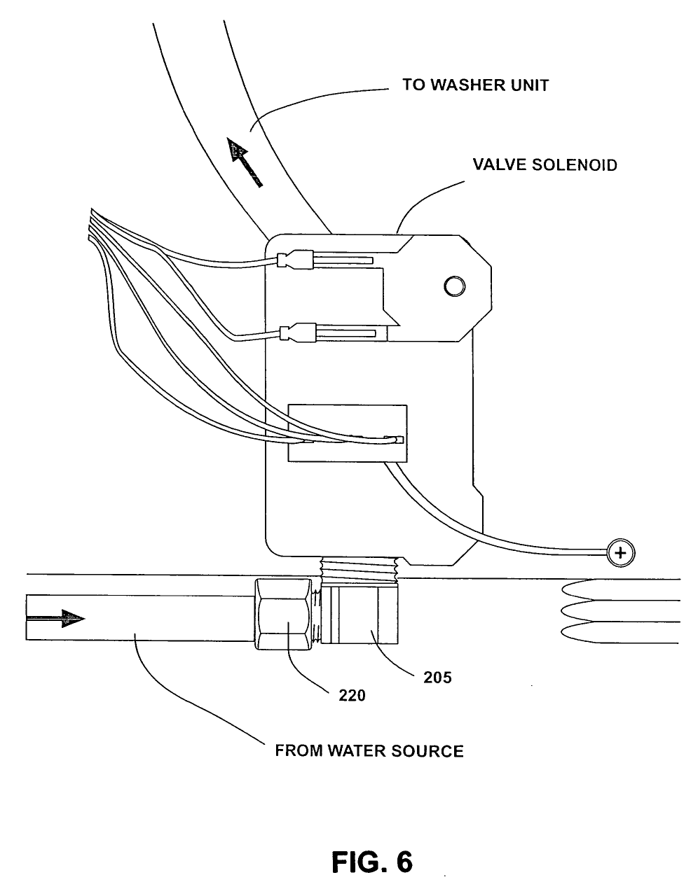

When the user wishes to remove or install the elbow 200, he or she fits the drive end 10 of the socket 100 to a wrench. During removal of the “dishwasher 90” the user inserts the wrench and socket combination into the space between the dishwasher and the floor or other supporting structure and then cups the main body 205 of the elbow 200 with the socket 100 as shown in FIGS. 5 and 6, so that the main body 205 of the elbow is received in the central cavity 20 of the socket with the bottom surface 209 of the main body 205 abutting against the abutment shelf 35 of the socket 100, and the waterline end 215 and neck 207 extending out through the notch 25. This will typically involve placement of the wrench so that the socket 100 is directly under the elbow 200, in the small space that is provided between the dishwasher and the floor, and lifting the socket and wrench combination straight up to cup the main body 205 and neck 207 of the elbow 200 in the central cavity 20 of the socket 100. The user then ratchets the wrench causing the socket 100 to turn the elbow 200, so that threads 212 on the conduit end 210 of the elbow 200 disengage the threads on the water conduit causing the elbow 200 to “fall away from” the water conduit, and to nest in the socket 100 for removal.

During installation of the elbow 200, the user may reach into the space between the dishwasher and the floor and partially thread the elbow 200 with the water conduit, and then cup the main body 205 of the elbow 200 with the socket 100, as shown in FIGS. 5 and 6, so that the main body 205 of the elbow is received in the central cavity 20 of the socket with the bottom surface 209 of the main body 205 abutting against the abutment shelf 35 of the socket 100, and the waterline end 215 and neck 207 extending out through the notch 25. Alternatively, the user may nest the elbow 200 in the central cavity 20 of the socket 100 and then “lift” the socket and wrench combination until the threads 212 on the water conduit end 210 engage the threads on the water conduit. The user then ratchets the wrench causing the socket 100 to turn the elbow 200, so that the threads 212 on the conduit end 210 continue to engage the threads on the water conduit until the elbow 200 is secured to the water conduit.

The size of the central cavity 20 of the socket 100 defined by the interior surface 30 and the abutment shelf 35 is generally the same size as the main body 205 of the elbow 200 only slightly larger. The main body 205 should fit snugly in the central cavity so that the sides A, B, C, D, E, F, and G of the main body 205 are touching the sides A′, B′, C′, D′, E′, F′, and G′ of the interior surface 30 of the socket 100 making it easier for the user to turn the elbow 200. The interior surface 30 of the socket 100 may be a different shape depending on the shape of the main body 205 of the elbow 200. For example, if the main body 205 of the elbow 200 is a cube, then the sides of the interior surface 30 of the socket 100 may be manufactured to form a central cavity 20 that is in the shape of a cube. Additionally, the exterior surface 5 of the main body of the socket 100 need not be a cylinder, for example, it may be the same shape as the interior surface 35 of the socket 100.

Although this invention has been described above with reference to particular means, materials and embodiments, it is to be understood that the invention is not limited to these disclosed particulars, but extends instead to all equivalents within the scope of the following claims.

What is claimed is:

1. A socket for rotationally loosening or tightening a dishwasher elbow fitting; wherein the dishwasher elbow fitting is comprised of two cylindrical bodies joined together by a 90° angle, with openings at both the vertical and horizontal ends to allow fluid flow-through, the socket comprising a cylindrical socket body having a planar first end face and an opposing planar second end face; wherein the socket body possesses an open top in the first end face and a closed bottom in the second end face; wherein the open top forms a receiving region that extends to partway between the first end face and the second end face for receiving the lower body portion of a dishwasher 90; wherein the receiving region includes an abutment against which the closed bottom end of the dishwasher 90 rests during rotation of the socket body; wherein a notch is formed in the circumference of the socket body adjacent to the receiving region and extends downwardly from the first end face partway to the second end face for receiving the horizontal portion of the dishwasher 90; and wherein the second end face includes a socket driver connector therein.

2. The socket as claimed in claim 1 wherein the receiving region is of a circular configuration.

3. The socket as claimed in claim 1 wherein the receiving region is of a polygonal configuration.

4. The socket as claimed in claim 3 wherein the receiving region includes an abutment.

5. The socket as claimed in claim 3 wherein the notch is of a square configuration.

6. The socket as claimed in claim 3 wherein the socket driver connector comprises an aperture for receiving a post on the socket driver.

7. The socket as claimed in claim 3 wherein the socket driver connector comprises a post that extends downward from the closed-bottom second end face for receiving an aperture or opening in a rotation tool.
